(19) United States
(12) Patent Application Publication
(10) Pub. No.: US 2004/0250069 A1
(43) Pub. Date: Dec. 9, 2004

(54) Adapting securityparameters of services provided for a user terminal in a communication network and correspondingly secured data communication

(76) Inventor: Rauno Kosamo, Lempaala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/489,330

(22) PCT Filed: Sep. 25, 2001
(86) PCT No.: PCT/EP01/11066

(51) Int. Cl. H04L 9/00

(52) U.S. Cl. 713/168; 713/150

(57) ABSTRACT

The present invention relates to a method for adapting security parameters of services provided for a user terminal in a communication network, the method comprising the steps of: initiating (S10), from the user terminal, an adaptation procedure towards the network, informing (S11) in response thereto, by said network, said user terminal of security parameters available for the services provided for said user terminal, selecting (S12), at said user terminal, at least one security parameter per service, and storing (S14) said selected security parameters per service per user in the network. Also, the present invention concerns a method for communicating data via a communication network to/from a user terminal having subscribed to said network, said method comprising the steps of: requesting (S20) a call to be established for said user terminal, retrieving (S21) security parameters from a subscriber database entity (HSS) of said network for said requested call, informing (S22) a security parameter processing entity (BS) of said network about the retrieved security parameters for said user terminal, and activating (S23) security processings for data communicated to/from said user terminal as defined by said security parameters per service for said user terminal at said security parameter processing unit.

### FIELD OF THE INVENTION

The present invention relates to a method for adapting security parameters of services provided for a user terminal in a communication network. Also, the present invention relates to a method for communicating data via a communication network to/from a user terminal having subscribed to said network.

### BACKGROUND OF THE INVENTION

In recent years, communication technology has made considerable progress. Currently, communication networks are under development which allow a variety of services to be accessed by a user by means of his user terminal.

An example of such a communication network is the 3^{rd} generation (3G) communication network also known as UMTS network (Universal Mobile Telecommunication Standard). Although the subsequent description of the present invention mainly focuses on the example of UMTS as a communication network, the present invention is not limited to be applied to a UMTS network. Rather, the present invention may be implemented to any other suitable and/or similar communication network, i.e. to a wireless network as well as to a wirebound network.

In such networks, user data will increasingly be transmitted using the Internet Protocol (IP). Also, networks are interconnected and hence data will be routed via various networks. Consequently, some data areas will—with an increasing probability—also become available and/or accessible for unauthorized persons.

In order to secure user data against unauthorized access, encryption (ciphering) of user data is required. Currently, encryption is defined by the network operator such that on one hand all user data is encrypted or on the other hand no user data is encrypted at all.

If all user data is encrypted, extra hardware and/or processing capacity for encryption is needed. The amount of encryption processing capacity will significantly increase the more users subscribe to communication networks and the more user data traffic may thus be expected. It is thus undesirable from a hardware point of view to encrypt all user data, since this would involve significant hardware costs for the network operators.

If, however, no user data is encrypted, this is not preferred by the users as their confidential data may be “visible” to unauthorized persons tapping the user data flow in the network.

### SUMMARY OF THE INVENTION

Hence, it is an object of the present invention to provide a method for adapting security parameters of services provided for a user terminal in a communication network, and a method for communicating data via a communication network to/from a user terminal having subscribed to said network which are free from the above mentioned drawbacks and which provide a high amount of user data security while reducing a required hardware amount.

According to one aspect of the present invention, this object is for example achieved by a method for adapting security parameters of services provided for a user terminal in a communication network, the method comprising the steps of: initiating, from the user terminal, an adaptation procedure towards the network, informing in response thereto, by said network, said user terminal of security parameters available for the services provided for said user terminal, selecting, at said user terminal, at least one security parameter per service, and storing said selected security parameters per service per user in the network.

According to favorable refinements of this aspect of the present invention,

said security parameters are kept in a subscriber database entity (HSS) of the network,

said security parameters define a level of data encryption to be applied by said network to data transmitted to/from said user terminal, and

said selecting is a forced selection dependent on a respective service.

Still further, according to another aspect of the present invention, this object is for example achieved by a method for communicating data via a communication network to/from a user terminal having subscribed to said network, said method comprising the steps of: requesting a call to be established for said user terminal, retrieving security parameters from a subscriber database entity of said network for said requested call, informing a security parameter processing entity of said network about the retrieved security parameters for said user terminal, and activating security processings for data communicated to/from said user terminal as defined by said security parameters per service for said user terminal at said security parameter processing unit.

According to favorable refinements of this aspect of the present invention,

said security parameter processing entity is an access node of said communication network, and

said activated security processings represent respective data encryption processings, the encryption level of which is defined by said security parameters.

Thus, with the present invention being implemented to a communication network, the following advantages are obtained:

the end user is enabled to choose security parameters for his user data, e.g. whether encryption of his user data is performed or not,

also, it is up to the end user to choose as security parameter the level of encryption and thus the degree of security for the encrypted data,

the user may select security parameters (such as e.g. level of encryption) of his user data separately for each service and/or application he subscribed to at the network,

the operator is alleviated from the burden to decide whether or not to encrypt user data and also relieved from the necessity to provide encryption hardware/processing capacity adapted to encrypt all user data traffic that might be expected to occur in the network in a worst case scenario,

thus, resources are saved because e.g. only “critical cases” (security sensitive services) can be configured to be encrypted, while when regarded from another point of view those “critical cases” at the same time benefit from a better encryption than would be provided normally for these service/applications which require “extra” encryption as compared to “normal cases”,

the encryption levels representing security parameters can be configured beforehand, i.e. before their actual use, as they are stored in a subscriber database entity upon a setting/modification of the security parameters.

### BRIEF DESCRIPTION OF THE DRAWINGS

Further details, features and advantages of the present invention will become fully apparent upon reading the subsequent specification in conjunction with the accompanying drawings, in which:

FIG. 1 illustrates a signaling diagram of the signaling involved between a user terminal and network entities in connection with the first aspect of the present invention, and

FIG. 2 illustrates a signaling diagram of the signaling involved between a user terminal and network entities in connection with the second aspect of the present invention.

### DETAILED DESCRIPTION OF THE EMBODIMENTS

The present invention will now be described in detail with reference to the drawings.

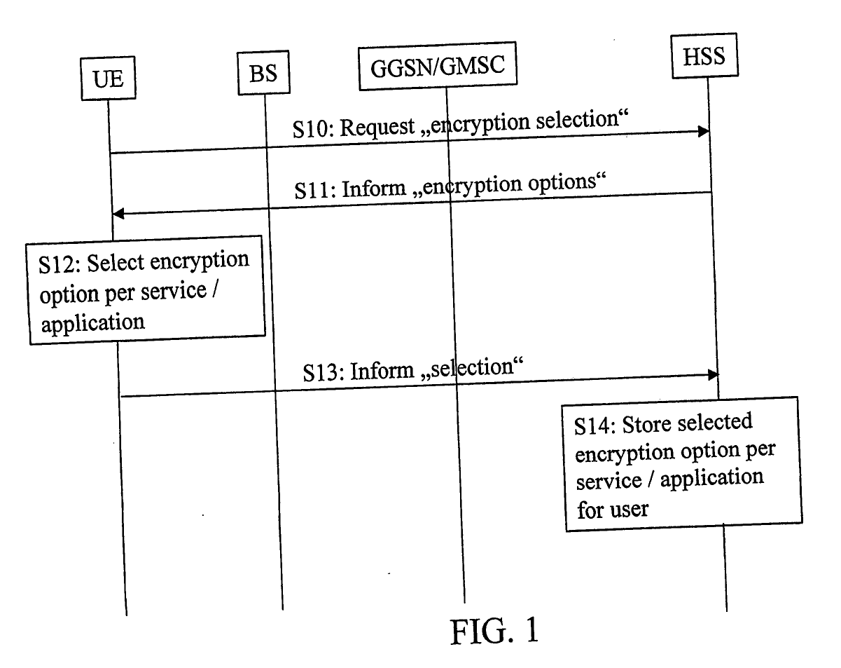

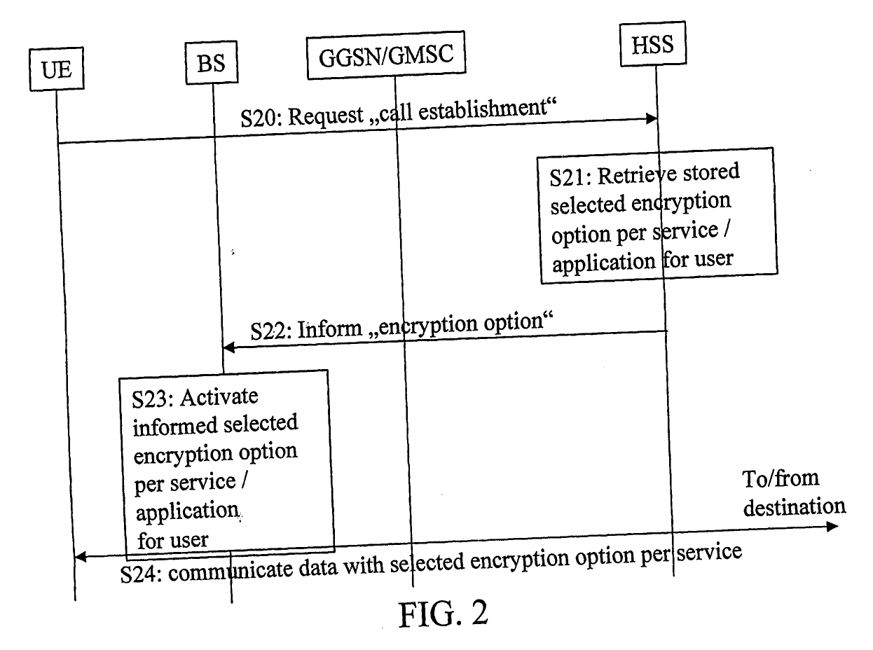

It is to be noted that in both drawings, FIGS. 1 and 2, only those network entities are shown which are involved in implementing the present invention. Thus, the network architecture is not entirely illustrated but rather roughly simplified.

Denoted with UE is a user terminal known as user equipment in UMTS. In GSM, this corresponds to a mobile station (MS), while it is not required that the user terminal is a mobile and/or wireless terminal in order for the present invention to be implemented.

The user terminal UE communicates with the network. The network is represented by a base station BS also known as Node_B in UMTS. The base station BS represents an access node for the terminal to the network. In case of wireless terminals, the base station BS is part of the radio access network RAN of the UMTS network. The access network in turn is connected to the core network CN which is independent of the access technology used in the access network. The core network is represented by a GGSN/GMSC, i.e. a Gateway GPRS Support Node (GPRS=General Packet Radio Service)/Gateway Mobile Services Switching Center. These may be separate entities, but may also be a combined entity taking care of both services. That is, the GPRS part is mostly responsible for data services, while the other part is mostly responsible for speech services and/or short message services. It is however to be noted that data/speech/SMS are only examples of services available in such a communication network and various other services are possible. Also, with an above mentioned service (which could be referred to as service category) different individual services are possible (e.g. with speech services there are full rate, half rate etc. traffic channels selectable as different services). Other services may be the sending of e-mails via the user equipment, browsing the Internet (world wide web WWW), or the like.

Most generally, “service” as used in the present invention is intended to mean a set of functions offered to a user (subscriber) by an organization (such as the network operator). Also, such a set of functions may be named “application” (a set of security mechanisms, files, data and protocols) as an application may comprise one or more services. For a service actually to be used by a user (represented by his terminal UE and referred to as A-subscriber) when performing communication with a communication partner (referred to as B-subscriber) a communication channel between the two has to be active (or to be activated). Such a communication channel is known as “connection” which has to be established. More generally, whether connection oriented or connection less, communication between e.g. the A- and B-subscriber requires a logical association between the users/subscribers involved in the communication. Such a logical association is referred to as a “call”. Of course, the above definitions are not restricted to only two subscribers involved but also apply to a multi-subscriber communication (“group call”) in which more than two communication partners are involved. Thus, for each service/service type a call will be established in order for the service being actually made use of.

The GGSN/GMSC is connected to a database entity keeping a record of subscriber/user data named home subscriber server HSS. The functionality of the HSS in UMTS largely corresponds to the one of the home location register HLR in GSM, so that a detailed description thereof is considered to be dispensable as a skilled person may safely be assumed to know about these functionalities. It is however to be noted that the database entity keeping a record of subscriber/user data need not necessarily be the home subscriber server. Rather, such an entity may be provided independent and/or separate from the home subscriber server HSS. At least those subscriber data records necessary in connection with the implementation of the present invention have to be stored in such a database entity. Thus, if the HSS also takes care of these subscriber data records, its database has to be extended by these records as compared to a known and already standardized HSS. Likewise, the data transfer and protocols used on the interfaces between the network entities are not described in detail as a skilled person may safely be assumed to know about these details, which are not a primary concern of the present invention.

FIG. 1 illustrates a signaling diagram of the signaling involved between a user terminal and network entities in connection with the first aspect of the present invention, i.e. the signaling involved in a method for adapting security parameters of services provided for a user terminal in a communication network.

As shown in FIG. 1, the user terminal UE in step S10 requests encryption selection to the database entity keeping a record of subscriber/user data, here represented as the home subscriber server HSS and thus initiates an adaptation procedure towards the network. It is to be understood that the HSS performs an authentication procedure (not shown) in order to verify that the user terminal issuing the request is authorized to do so, i.e. has subscribed to the network. If the verification fails, the HSS returns an encryption selection denied message to the requesting terminal. If the verification is positive, the HSS returns an information about the possible options for encryption offered by the network to the user, see step S11. These options may at least be network specific but may also be user specific (e.g. depend on the user's subscription profile) and/or may be service specific. Stated in other words, in step S11, said network informs said user terminal UE of security parameters available for the services provided for said user terminal.

The encryption options as an example of security parameters are made available at the user terminal for selection by the user, e.g. using a man machine interface such as a display in connection with selection keys of a keyboard (“navigating keys” such as cursor keys). The options may e.g. be presented in a specific selection menu for selecting one or more encryption options/security parameters. The user then selects one or more of the offered/available security parameters (step S12). The selection is performed on a per service basis so that for each service a security parameter is defined.

If the user does not define a security parameter for a specific service, a default parameter may be set. In order to reduce an encryption load, a default value of a security parameter may be set to a low security level corresponding to a “low” encryption. Generally, said security parameters define a level of data encryption to be applied by said network to data transmitted to/from said user terminal.

It is to be noted that certain applications/services may themselves be aware of a security level they require. Thus, they would not act on a lower encryption level than they require. This means, that a default security level may be defined beforehand per application/service. Such a default security level per application may be configured for the application to be higher than the lowest security level. Thus, the user may be free to select the security level, since if he does not select, an appropriate security level is selected as a default level by the application/service itself. In some cases, the application/service is available only for one security level, and in this case, the user even can no longer select the security level on his own motion but is bound by the “selection” performed by the application/service itself. Thus, in the above case, the selecting is a forced selection dependent on a respective service, i.e. one which does not involve a user interaction. The “selection” of a security level by the application/service itself is effected via an interface between the application and the protocol stack of the terminal.

Upon completion of the selecting of at least one security parameter per service, the user terminal UE informs the network about the selection (step S13) and said selected security parameters per service per user are stored in the network (S14). More precisely, the security parameters are kept in a subscriber database entity (HSS) of the network. This means that the subscriber records maintained at the HSS per individual user are supplemented by the selected security parameters per service for each respective user.

The above described procedure of steps S10 to S14 is for example performed at an initialization of the user terminal by the user. Nevertheless, it may be performed afterwards by the user in case he wishes to change his security level for a particular service.

Once the security parameters of services provided for a user terminal in the communication network have been adapted and/or set as described before, they are available for being used in communications in which the user terminal participates.

FIG. 2 illustrates a signaling diagram of the signaling involved between a user terminal and network entities in connection with the second aspect of the present invention, i.e. of a method for communicating data via a communication network to/from a user terminal having subscribed to said network.

In step S20, the user terminal requests a call establishment to the network, more specifically, to the subscriber database entity HSS. Not shown in FIG. 2 is the verification procedure conducted by the HSS to confirm that the user terminal is authorized to access services provided by the network (authentication procedure as mentioned earlier above). If the user terminal is authorized and has thus be confirmed to have subscribed to the network, the subscriber database entity HSS in step S21 retrieves the (previously selected) stored encryption options (security parameters) from a corresponding storage location at the HSS. The encryption parameters are stored per user on a per service level (per application level).

The retrieved encryption options representing the security parameters are transferred from the database entity HSS in step S22 to the access node, i.e. the base station BS or the Node_B. Thus, informing a security parameter processing entity (i.e. the base station) of said network about the retrieved security parameters for said user terminal is accomplished.

In response thereto, in step S23, security processings for data communicated to/from said user terminal as defined by said security parameters per service for said user terminal at said security parameter processing unit BS are activated. Then, in step S24, the data communicated from/to the user terminal UE via the base station BS and the network (GGSN/GMSC) to/from a destination such as a further user terminal (not shown) are subjected to the activated encryption according to the selection, so that data are secured/encrypted per user and per service in line with the user's selection.

Note that a security processing is intended to mean any data treatment suitable to provide a certain security level for the data. A security level may also refer to a confidentiality level which is currently defined as level zero (no confidentiality) up to level 3 (confidentiality meets constraints of military or strategic users).

The security parameters were mentioned to be defined on a per service and/or per application level per user. Also, it is possible to perform a definition on a per data contents level by the user within a service and/or application.

Although the present invention has been described herein above with reference to its preferred embodiments, it should be understood that numerous modifications may be made thereto without departing from the spirit and scope of the invention. It is intended that all such modifications fall within the scope of the appended claims.

1-6. (Cancelled).

7. A method for adapting security parameters of services provided for a user terminal in a communication network, the method comprises the steps of:
initiating, from the user terminal, an adaptation procedure towards the network,
information in response thereto, by said network, said user terminal of security parameters available for the services provided for said user terminal,
selecting, by the user at said user terminal, at least one security parameter per service, and
storing said selected security parameters per service per user in a subscriber database entity of the network.

8. A method according to claim 7, wherein said security parameters define a level of data encryption to be applied by said network to data transmitted to/from said user terminal.

9. A method according to claim 7, wherein said selecting is a forced selection dependent on a respective service.

10. A method for communicating data via a communication network to/from a user terminal having subscribed to said network, said method comprising the steps of:
requesting a call to be established for said user terminal,
retrieving user selected security parameters from a subscriber database entity of said network for said requested call,
informing a security parameter processing entity of said network about the retrieved security parameters for said user terminal, and
activating security processing for data communicated to/from said user terminal as defined by said security parameters per service for said user terminal at said security parameter processing unit.

11. A method according to claim 10, wherein said security parameter processing entity is an access node of said communication network.

12. A method according to claim 10, wherein said activated security processing represented respective data encryption processings, the encryption level of which is defined by said security parameters.
